(19) United States
(12) Patent Application Publication
(10) Pub. No.: US 2023/0232867 A1
(43) Pub. Date: Jul. 27, 2023

(54) COMPOSITION COMPRISING AN OIL PHASE AND AN AQUEOUS PHASE

(71) Applicant: Givaudan SA, VERNIER (CH)

(72) Inventors: Susanne STEGHÖFER, Winterthur (CH); Lena Lore HECHT, Wallisellen (CH); Samuel STENGEL, Meilen (CH)

(21) Appl. No.: 18/001,287

(22) PCT Filed: Jun. 29, 2021
(86) PCT No.: PCT/EP2021/067914

§ 371 Date: Dec. 9, 2022

(30) Foreign Application Priority Data
Jul. 1, 2020 (GB) 2010053.3

(51) Int. Cl. A23L 2/62; A23L 2/06; A23L 2/56; A23L 2/44; A23L 2/68

(52) U.S. Cl. CPC A23L 2/62; A23L 2/06; A23L 2/44; A23L 2/56; A23L 2/68

(57) ABSTRACT

The present disclosure relates to compositions comprising an oil phase and an aqueous phase comprising sugar beet pectin and at least one pectin selected from a different plant, to a method of preparation of such compositions, to compositions obtainable by said method, to food and beverage products comprising such compositions, and to the use of such compositions for obtaining cloudy beverages.

The present disclosure relates to compositions comprising an oil phase and an aqueous phase comprising sugar beet pectin and at least one pectin selected from a different plant, to a method of preparation of such compositions, to compositions obtainable by said method, to food and beverage products comprising such compositions, and to the use of such compositions for obtaining cloudy beverages.

The use of clouding systems to provide cloudy beverages, such as orange-or lemon-flavored drinks, is well known to the art. These clouding systems typically consist of aqueous suspensions of solid particles or oil-in-water emulsions which are stabilized by colloidal stabilizing agents, such as surfactants and hydrocolloids. The cloudiness stems from the visible light scattering induced by the plurality of solid particles or oil droplets present in the system, as dispersed material. When diluted in a beverage, the clouding system confers the beverage a cloudy appearance.

In order to perform effectively, the clouding system must fulfill a certain number of conditions, such as particle or droplet size and difference of refractive index between the dispersed material and the beverage.

Solid materials that are considered as particularly useful in this context include titanium oxide, insoluble fruit fibers, and waxes. Liquid materials include vegetable oils, more particularly medium chain triglycerides, and essential oils. Flavor emulsions that usually combine oil-soluble flavor ingredients, vegetable oils, essential oils and, optionally, weighting agents may also serve as clouding systems.

US 2013/0,323,379 A1 discloses natural clouding systems for beverage applications comprising coconut, palm or canola oil and an emulsifier selected from gum Arabic or pectin. The systems furthermore comprise glycerin and/or ethanol as preservative. The examples in US 2013/0,323,379 A1 show that the oil level in the clouding system is limited to 10 wt.-%. Moreover, this document does not provide any information neither about the nature of the pectin used nor about the quality of the cloudiness obtained with such systems.

Hence, there remains a need for clouding systems that do not suffer from the drawbacks mentioned hereinabove.

### SUMMARY OF THE INVENTION

In a first aspect, a composition includes:
a) an oil phase;
b) an aqueous phase comprising sugar beet pectin and at least one other pectin, wherein the other pectin is obtained from a plant that is different from sugar beet.

In particular embodiments of the present disclosure, the composition comprises at least one oil product selected from:
a) a fruit oil, more particularly a bergamot oil, a grapefruit oil, a lemon oil, a terpene-less lemon oil, a lime oil, a terpene-less lime oil, a mandarin oil; an orange cold pressed oil, and orange essence oil; a tangerine cold pressed oil; or a tangerine essence oil; and
b) a vegetable oil, a transformed vegetable oil, or a vegetable oil fraction, more particularly a vegetable oil fraction comprising medium chain triglycerides, more particularly C 8 to C 12 triglycerides.

In particular embodiments of the present disclosure, the at least one other pectin is a citrus pectin.

In particular embodiments, the citrus pectin has a viscosity of 400 to 500 mPas, when dissolved at a level of 4 wt.-% in deionized water and measured at 25° C. by using a Brookfield LVDV 3 instrument equipped with a Spindel 3, rotating at a speed of 30 rpm, and a degree of esterification of from 60 to 90%, more particularly from 65 to 80%.

In particular embodiments, the composition comprises, based on the total weight of the composition:
a) From 0.5 to 25 wt.-%, more particularly from 5 to 20 wt.-%, still more particularly from 10 to 20 wt.-% of oil phase; and
b) From 0.5 to 5 wt.-%, more particularly from 1 to 3, still more particularly from 1.5 to 2.5 wt.-% of pectins.

In particular embodiments, the composition additionally comprises at least one benefit agent selected from the group consisting of at least one flavor ingredient, vitamins, carotenoids, and antioxidants.

In particular embodiments, the composition additionally comprises at least one preservative.

In particular embodiments, the oil phase is dispersed in the aqueous phase in the form of droplets, forming thereby an oil-in-water emulsion.

In particular embodiments, the oil droplets have a volume-median diameter D(50) of from 0.2 to 0.7, more particularly from 0.3 to 0.5 µm.

In particular embodiments, the composition additionally comprises a weighting agent, wherein the weighting agent is selected from the group consisting of sucrose esters, such as sucrose acetate isobutyrate (SAIB), polyol fatty acid esters, polyol benzoates, dammar gum, rosin gums, and ester gums, and wherein the level of the weighting agent is up to 70% based on the total amount of oil phase contained in the composition.

In particular embodiments, the composition has a pH of 5, more particularly 4 or less, still more particularly 3.5 or less.

In a second aspect, the present disclosure provides a method to obtain the composition by performing the steps of:
a) Preparing an oil phase;
b) Preparing an aqueous phase comprising a sugar beet pectin and at least one other pectin;
c) Mixing the aqueous phase and the oil phase in order to obtain a composition;
d) Optionally: adjusting the pH by adding citric acid, malic acid, acetic acid, ascorbic acid, lactic acid, tartaric acid, phosphoric acid, or a mixture thereof;

Step a) and step b) are interchangeable.

In regard to step b), the pectin may be let to equilibrate in water before adding the oil phase. Alternatively, the pectin maybe added after having mixed the water and the oil phase.

In regard to step d), the pH adjustment may be performed before adding the oil phase in step c) or after.

In particular embodiments, the method additionally comprises the step of adding at least one benefit agent.

In particular embodiments, the method additionally comprises the step of adding at least one preservative.

In particular embodiments, the method additionally comprises the step of applying high pressure homogenization to the composition in order to form an emulsified composition.

In a third aspect, the present disclosure provides compositions obtainable by the method according to the present disclosure.

In a fourth aspect, the present disclosure provides a food or beverage product comprising the composition according to the present disclosure.

In particular embodiments, the food or beverage product comprises, based on the total weight of the product, from 0.01 to 1.0 wt.-%, more particularly from 0.05 to 0.5 wt.-% of a composition, the composition comprising:
a) From 1 to 25 wt.-%, more particularly from 5 to 20 wt.-%, still more particularly from 10 to 20 wt.-% of oil phase; and
b) From 0.5 to 5 wt.-%, more particularly from 1 to 3, still more particularly from 1.5 to 2.5 wt.-% of pectins.

In particular embodiments, the food or beverage product has a transparency of less than 50 mm, more particularly less than 40 mm.

In a fifth aspect, the present disclosure provides the use of the composition according to the present disclosure as for obtaining cloudy beverages.

### DESCRIPTION OF THE FIGURES

The embodiments set forth in the drawing are illustrative in nature and not intended to limit the invention defined by the claims. The following detailed description of the illustrative embodiments can be understood when read in conjunction with the following drawing, where like structure is indicated with like reference numerals and in which:

FIG. 1 shows oil droplet diameter distribution density on a logarithmic abscissa obtained by using sugar beet pectin only, citrus pectin and a mixture of sugar beet pectin and citrus pectin. A = size classes (in micrometer), B = volume density (in percentage/log(µm)), SBP = sugar beet pectin, CP = citrus pectin;

FIG. 2 sets forth transparency values for beverages in accordance with one aspect of the present disclosure; and

FIG. 3 sets forth transparency values for beverages in accordance with one aspect of the present disclosure.

### DETAILED DESCRIPTION OF THE INVENTION

The applicant has discovered that by combining pectin from different plants, more particularly by combining sugar beet pectin with at least one other pectin obtained from a plant that is different from sugar beet, a composition could be obtained that forms stable emulsions, without requiring any additional surfactant or emulsifier.

By “stable emulsion” is meant an emulsion that does not phase separate over a prolonged period of time when submitted to storage test conditions, such as three months at 20° C. and at 40° C. The terms “emulsion” and “emulsified composition” are considered as equivalent in the context of this disclosure.

More particularly, the applicant has discovered that the emulsions obtained comprise oil droplets, the diameter of which can be controlled by controlling the weight ratio of sugar beet pectin to the at least one other pectin, providing thereby an optimal balance between emulsion stability and cloudiness, and making such emulsions particularly suitable as emulsions and clouding systems for food and beverage products. This was not anticipated by the state of the art.

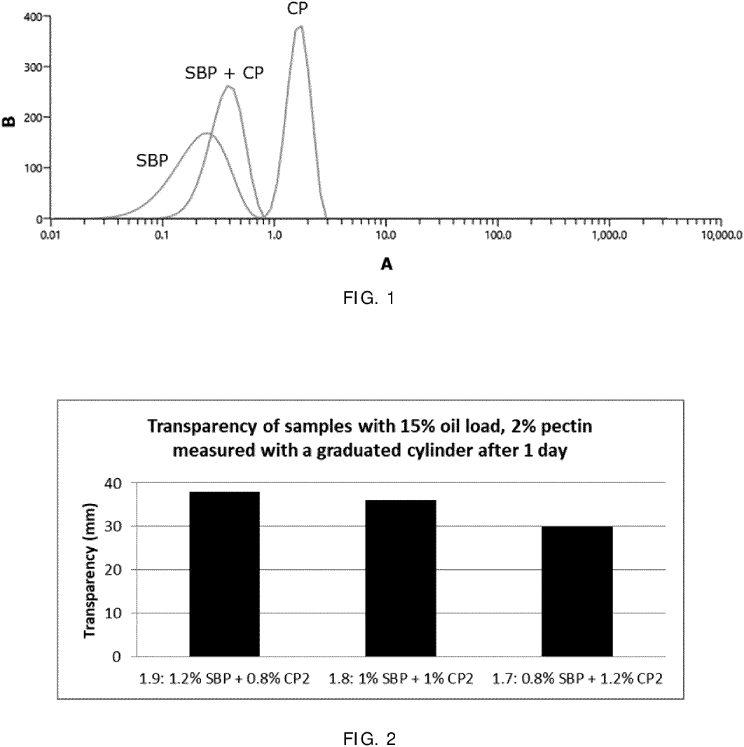

This surprising discovery is illustrated by the oil droplet diameter distribution shown in FIG. 1. In particular, FIG. 1 shows that the droplet diameter distribution obtained with sugar beet pectin alone is in the lower diameter range of the graph. The corresponding emulsion is stable, but less efficient with respect to clouding. Conversely, the droplet diameter distribution obtained with citrus pectin alone is located in the upper diameter range of the graph, meaning the emulsion obtained may provide efficient clouding, but is not stable enough with respect to phase separation, for example by creaming. However, mixing both pectins result in a droplet diameter distribution that offers the best compromise in terms of stability and clouding efficiency.

By “cloudiness” is meant the property of a medium to refract, scatter or diffuse light, in such a way that this medium appears turbid to the human eye. Cloudiness may, interchangeably, be measured by performing a turbidity measurement or a transparency measurement. Turbidity may be interpreted as the reciprocal of transparency. The highest the transparency, the lowest the turbidity is. The transparency is measured by assessing the maximal distance in the liquid at which some pattern may be identified by the human eye. Typically, a series of characters, for example a word, having a defined size and font, is written on a white surface and the surface is placed under a glass cylinder graduated in millimeter (mm). The cylinder is filled with the cloudy liquid until the character or the word cannot be identified or read by the human eye. Alternatively, a printed pattern, for example a black and white pattern can be used. The distance between the meniscus of the liquid and the written pattern is taken as a measurement of the transparency limit, expressed in mm. The higher the transparency limit is, the lower the cloudiness. For instance, the cylinder may be a 50 ml graduated cylinder having 2 cm diameter. In the present disclosure, transparency will be used.

By “cloudy food or beverage product” is meant a product that scatters the light in such a way that the human eye cannot see through it, unless the thickness of the product is below the transparency limit defined hereinabove.

In one aspect, the composition comprises:
a) an oil phase;
b) an aqueous phase comprising sugar beet pectin and at least one other pectin, wherein the other pectin is obtained from a plant that is different from sugar beet.

The oil phase comprises components that are essentially soluble in oil and the aqueous phase comprises components that are essentially soluble in water.

By “essentially soluble in the oil phase” is meant that, typically, more than 90 wt.-% of these essentially oil-soluble components are forming an oil phase. Similarly, by “essentially soluble in water”, is meant that, typically, more than 90 wt.-% of these essentially water-insoluble components are forming an aqueous phase.

The aqueous phase also comprises the pectins.

In preferred embodiments, the oil phase comprises oil products derived from natural resources. More particularly, the oil products have a refractive index that is different from the refractive index of water (n = 1.33), wherein the refractive index, represented by symbol n, is the velocity of light in vacuum divided by the velocity of light in a medium, the wavelength of the light being equal to 589 nanometers. Typically, the refractive index of the oil phase is from 1.40 to 1.55 at 20° C. A difference of refractive index between the oil phase and the aqueous phase is one of the factors that enhance the cloudiness of the emulsion.

In preferred embodiments, the oil phase comprises at least one oil product selected from:
a) a fruit oil (n = 1.46 - 1.49), more particularly a bergamot oil, a grapefruit oil, a lemon oil, a terpene-less lemon oil, a lime oil, a terpene-less lime oil, a mandarin oil; an orange cold pressed oil, and orange essence oil; a tangerine cold pressed oil; or a tangerine essence; and
b) a vegetable oil, a transformed vegetable oil (n=1.44 - 1.50), or a vegetable oil fraction, more particularly a vegetable oil fraction comprising medium chain triglycerides, more particularly C 8 to C 12 triglycerides (n =1.44 - 1.45).

Pectins typically consist of linear main chains comprising β-1,4-linked galacturonic acid and rhamnose units, with side-chains (branches) comprising neutral sugars, more particularly galactose and arabinose. Part of the carboxylic groups of galacturonic acid may be in the form of methyl ester, while part of the hydroxyl groups present on the pectin macromolecule may be acetylated.

Sugar beet pectins are characterized by high protein content in comparison to pectins from other sources. Additionally, in sugar beet pectin some side chain arabinose and galactose can be esterified with ferulic acid. Without being bound by any theory, it may be expected that these characteristics are responsible for the emulsifying activity of sugar beet pectin.

The at least one other pectin that is combined with sugar beet pectin may be selected from the group consisting of citrus pectins and apple pectins, more particularly apple pomace pectins, sunflower seed and mango waste.

In particular embodiments, the at least one other pectin is a citrus pectin.

Citrus pectins that are particularly advantageous for the sake of the present disclosure have a high degree of esterification, are substantially not amidated and have a low viscosity. More particularly, the degree of esterification is higher than 50%, more particularly higher than 65%, still more particularly from 65% to 80%.

The viscosity may be measured by any method known to the art, provided this method can measure the viscosity at the appropriate shear rate.

In particular embodiments, the citrus pectin has a viscosity of 400 to 500 mPas, when dissolved at a level of 4 wt.-% in deionized water and measured at 25° C. by using a Brookfield LVDV 3 instrument equipped with a Spindel 3, rotating at a speed of 30 rpm, and a degree of esterification of from 60 to 90%, more particularly from 65 to 80%.

In particular embodiments of the present disclosure, the weight ratio of the sugar beet pectin to the citrus pectin is from 0.75 to 9, more particularly from 1 to 4, still more particularly from 1 to 2.5. If this ratio is too low or too high, then the emulsified composition may not be stable and phase separate over time.

In particular embodiments, the composition comprises, based on the total weight of the composition:
a) From 1 to 25 wt.-%, more particularly from 5 to 20 wt.-%, still more particularly from 10 to 20 wt.-% of oil phase; and
b) From 0.5 to 5 wt.-%, more particularly from 1 to 3, still more particularly from 1.5 to 2.5 wt.-% of pectins.

If the level of pectins is too high, the viscosity may increase during emulsification at such an extent that the emulsion may not be further processed. On the other hand, if the oil phase to pectin weight ratio is too high, then the level of pectin may not be sufficient to effectively stabilize the emulsion.

In particular embodiments of the present disclosure, the composition additionally comprises at least one benefit agent selected from the group consisting of flavor ingredients, vitamins, carotenoids, and antioxidants.

In particular embodiments of the present disclosure the at least one benefit agent is at least one flavor ingredient selected from the group consisting of 1,1-diethoxyethane; 3-hydroxybutan-2-one; 1-phenylethanone; (Z)-oxacycloheptadec-10-en-2-one; benzaldehyde; 2-methylpropyl acetate; 2-methylpropyl 2-methylbutanoate; butanal; butyric acid; 2-methylpropanoic acid; 2-methyl-5-prop-1-en-2-ylcyclohex-2-en-1-ol; (2E)-3-phenylprop-2-enal; cinnamon oil leaf; (E)-3,7-dimethylocta-2,6-dienal; 3,7-dimethyloct-6-enal; 3,7-dimethyloct-6-en-1-ol; (E)-1-(2,6,6-trimethylcyclohexa-1,3-dien-1-yl)but-2-en-1-one; 6-pentyltetrahydro-2H-pyran-2-one; 5-hexyloxolan-2-one; decanal; chroman-2-one; methyl 2-(methylamino)benzoate; dimethyl sulfide; oxydibenzene; 1-methyl-4-prop-1-en-2-ylcyclohexene; 5-octyloxolan-2-one; ethyl acetate; ethyl butanoate; ethyl 2-methylpropionate; ethyl 3-phenylprop-2-enoate; ethyl decanoate; 6-ethyl-1,5,5-trimethylbicyclo[2.2.1]heptan-6-ol; ethyl formate; ethyl heptanoate; ethyl hexanoate; ethyl 3-hydroxybutanoate; ethyl 3-hydroxyhexanoate; ethyl 2-methylbutanoate; ethyl octanoate; ethyl 3-methylbutanoate; ethyl propionate; 4-ethylphenol; pent-1-en-3-one; 2-methyl-5-propan-2-ylcyclohexa-1,3-diene; 7,11-dimethyl-3-methylidenedodeca-1,6,10-triene; 2-ethyl-4-hydroxy-5-methylfuran-3-one; (E)-3,7-dimethylocta-2,6-dien-1-ol; (E)-3,7-dimethylocta-2,6-dien-1-yl acetate; hexanal; hexanoic acid; E-hex-2-enal; (Z)-hex-3-en-1-ol; (Z)-hex-3-en-1-yl acetate; (E)-4-(2,6,6-trimethyl-1-cyclohex-2-enyl)but-3-en-2-one; (E)-4-(2,6,6-trimethylcyclohex-1-en-1-yl)but-3-en-2-one; 3,7-dimethylocta-1,6-dien-3-ol; 3,7-dimethylocta-1,6-dien-3-yl acetate; 3-hydroxy-2-methyl-4H-pyran-4-one; mandarin oil; 4-methyl-4-sulfanylpentan-2-one; 2-(4-methylcyclohex-3-en-1-yl)propane-2-thiol; mercapto-para-menthan-3-one; methyl acetate; methyl 2-aminobenzoate; 2-methyl-butanoic acid; methyl 3-phenylprop-2-enoate; methyl 3-oxo-2-pentylcyclopentaneacetate; 5-methylfuran-2-carbaldehyde; 7-methyl-3-methyleneocta-1,6-diene; (Z)-3,7-dimethylocta-2,6-dien-1-yl acetate; 5-pentyloxolan-2-one; nonanal; 4,4a-dimethyl-6-(prop-1-en-2-yl)-4,4a,5,6,7,8-hexahydronaphthalen-2(3H)-one; 5-butyloxolan-2-one; octanal; octanoic acid; orris concrete; osmanthus absolute; 2,3-pentanedione; 3-methylbutyl acetate; 3-methylbutyl 3-methylbutanoate; propyl acetate; rose oil; (2E,6E,9E)-2,6,10-trimethyldodeca-2,6,9,11-tetraenal; (2E,6E)-2,6-dimethyl-10-methylidenedodeca-2,6,11-trienal; tarragon oil; 4-methyl-1-propan-2-ylcyclohex-3-en-1-ol; 1-methyl-4-propan-2-ylcyclohexa-1,3-diene; 2-(4-methyl-1-cyclohex-3-enyl)propan-2-ol; 1-methyl-4-(propan-2-ylidene)cyclohex-1-ene; 2-(4-methylcyclohex-3-en-1-yl)propan-2-yl acetate; 4a,5-dimethyl-3-prop-1-en-2-yl-2,3,4,5,6,7-hexahydro-1H-naphthalene; 4-hydroxy-3-methoxybenzaldehyde; and mixture thereof. Without being bound by any theory, it may be expected that, under such conditions, the flavor ingredients will partition between the oil phase and the polar phase of the composition, depending on their polarity.

In particular embodiments of the present disclosure, the vitamins, carotenoids, and antioxidants that are suitable in the context of the present disclosure may be selected from the group consisting of retinol, retinyl acetate or retinyl palmitate, tocotrienols and tocopherol, vitamin D2 (ergocalciferol) and D3 (cholecalciferol), vitamin K, astaxanthin, lutein, lutein esters, fucoxanthin, curcuminoids, such as curcumin, demethoxycurcumin (DMC), and bisdemethoxycurcumin (BDMC), capsaicins, such as capsaicin, dihydrocapsaicin, and nordihydrocapsaicin, beta-carotene, lycopene, zeaxanthin, phytosterols, vinpocetine, resveratrol, epigallocatechin-gallate (EGCE), quercetin, ubiquinol and ubiquinone, omega-3s (DHA (docosahexaenoic acid) and EPA (eicosapentaenoic acid)).

The vitamins, carotenoids, and antioxidants may be used in pure form or in the form of an oleoresin, an extract or a powder. The concentration of the pure colorant and nutraceutical agent in oleoresins, extracts and powders may be less than 100 wt.-%, for example 5 wt.-%, 15 wt.-%, 30 wt.-%, 50 wt.-% or 75 wt.-%.

In particular embodiments, the extract comprising the benefit agent is in the form of a solution in ethanol, methanol, vegetable oil or in a mixture of ethanol and/or methanol and/or vegetable oil and water. The extract may optionally be dried to remove any excess solvent.

In a particular embodiment of the present disclosure, the level of the pure vitamins, carotenoids, and antioxidants is from 0.01 wt.-% to 25 wt.-%, in another embodiment from 0.1 to 10 wt.-%, in yet another embodiment from 0.5 to 5 wt.-%, based on the total weight of the composition.

In particular embodiments of the present disclosure, the composition additionally comprises at least one preservative.

Preservatives that are suitable for the sake of the present disclosure include sorbates and benzoates, more particularly potassium sorbate and sodium benzoate.

In particular embodiments of the present disclosure, the oil phase is dispersed in the aqueous phase in the form of droplets, forming thereby an oil-in-water emulsion. Such oil-in-water emulsion has the advantage of being easy to disperse in aqueous products, such as beverage products.

In particular embodiments, the oil droplets have a volume-median diameter D(50)of from 0.2 to 0.7, more particularly from 0.3 to 0.5 µm.

The static light scattering method used for measuring volume median diameter D(50) of the oil droplets involves laser diffraction particle size analysis and the Mie scattering theory. The principle of the Mie theory and how static light scattering can be used to measure the mean and median diameters of a plurality of particles having a distribution of sizes can be found, for example in H. C. van de Hulst, Light scattering by small particles. Dover, New York, 1981. The volume median diameter D(50) may be calculated by using the software provided with the light scattering measurement apparatus.

Typically, the droplet size distribution is comprised within the 0.1 to 1 µm range.

In particular embodiments, the composition additionally comprises a weighting agent, wherein the weighting agent is selected from the group consisting of sucrose esters, such as saccharose acetate isobutyrate (SAIB), polyol fatty acid esters, polyol benzoates, dammar gum, rosin gums, and ester gums, and wherein the level of the weighting agent is up to 70 wt.-% based on the total amount of oil phase contained in the composition. The weighting agent prevents dispersed oil phases that have a lower density than the polar continuous phase from phase separating by creaming.

The pH of the aqueous phase comprising the dissolved pectin may be intrinsically acidic. If necessary, the pH is lowered by adding citric acid, malic acid, acetic acid, ascorbic acid, lactic acid, tartaric acid, phosphoric acid, or a mixture thereof. An acidic pH is advantageous with respect to microbiological stability and pectin functionality and viscosity stability.

In particular embodiments of the present disclosure, the composition has a pH of 5 or less, more particularly 4 or less, still more particularly 3.5 or less.

In one embodiment, the present disclosure provides a method to obtain the composition by performing the steps of:
a) Preparing an oil phase;
b) Preparing an aqueous phase comprising a sugar beet pectin and at least one other pectin;
c) Mixing the aqueous phase and the oil phase in order to obtain a composition;
d) Optionally: adjusting the pH by adding citric acid, malic acid, acetic acid, ascorbic acid, lactic acid, tartaric acid, phosphoric acid, or a mixture thereof;

Step a) and step b) are interchangeable.

In regard to step b), the pectin may be let to equilibrate in water before adding the oil phase. Alternatively, the pectin maybe added after having mixed the water and the oil phase.

In regard to step d), the pH adjustment may be performed before adding the oil phase in step c) or after.

In regard to step a), the pectin may be let to equilibrate in water before adding the oil phase. Alternatively, the pectin maybe added after having mixed the water and the oil phase.

In regard to step d), the composition may be obtained by applying low to high shear dispersive forces, for example by using a propeller, a blade, a blender, a mixer, a stirrer or a rotor-stator mixer operating for example at a speed of 10′000 to 20′000 rpm.

In particular embodiments, the method according to the present disclosure additionally comprises the step of adding at least one benefit agent.

In particular embodiments, the method according to the present disclosure additionally comprises the step of adding at least one preservative.

In particular embodiments of the present disclosure, the method additionally comprises the step of:

e) Applying high shear forces to the composition, in order to obtain an emulsified composition.

In regard to step e), the composition obtained in step d) may be emulsified by using a high pressure homogenizer. The composition may be homogenized with high pressure homogenization by passing said composition once or more often through a valve. In general the pressure applied is about 20 to 100 MPa, more particularly about 30 to 80 MPa, still more particularly such as 30 or 40 MPa. The number of passes through the valve may be 1 to 10, more particularly 2 to 5, e.g. 3. In case that a two-stage homogenization valve is used, the composition is passed through two valves, wherein the pressure in the first valve is set to about 5-50%, more particularly 10 to 30%, e.g. 25% of the pressure in the second valve. The emulsion is homogenized for 1-10, more particularly 2 to 5, e.g. 3, passes through the two valves. Optionally, a cooling step in between passes may be applied, in particular when the temperature of the emulsion exceeds 40° C., which otherwise may lead to changes in the flavor profile or vitamin activity, in case that temperature sensitive flavors or vitamins are used.

In a particular embodiment, the method involves the method involves the steps of:
a) Mixing water, a sugar beet pectin, at least one other pectin and an oil phase;
b) Adding an oil phase to the aqueous phase obtained in step a);
c) Optionally, adjusting the pH by adding citric acid, malic acid, acetic acid, ascorbic acid, lactic acid, tartaric acid, phosphoric acid, or a mixture thereof; and
d) Mixing the aqueous and the oil phase in order to obtain a composition according to claim 1.

In a third aspect, the present disclosure provides a composition obtainable by the method according to the present disclosure.

In a fourth aspect, the present disclosure provides a food or beverage product comprising the composition according to the present invention.

The emulsified composition obtained in step e) may be added to food and beverage products, such as drinkable water, carbonated and non-carbonated soft drinks, energy drinks, sports drinks; a fruit juice, a fruit juice concentrate, a fruit pulp, or a mixture thereof; as well as alcoholic beverages, dairy products and non-dairy milk alternatives.

The fruit juice may be obtained by pressing fresh fruit and removing the insoluble pulp, skin and seeds.

A fruit juice concentrate is processed to remove a defined proportion of the natural water content found in the fruit and produce a concentrated product which is smaller in volume.

A fruit pulp (or puree) is a thick, smooth product, which has been processed such that the insoluble fibrous parts of the fruit are broken up so as to be able to fit through a fine sieve.

The composition may be diluted in water, or admixed with a fruit juice or a fruit juice concentrate, which can be further diluted in an aqueous phase comprising, optionally, at least one citrate compound to form a beverage composition according to the present disclosure, wherein the level of the citrate compound in the aqueous phase is set in such a way that the level of the citrate compound in the beverage composition is from about 0.3 to about 0.7 wt.-%. The citrate compound may be selected from sodium citrate, potassium citrate, or mixtures thereof. The beverage composition may also include malic acid, acetic acid, ascorbic acid, lactic acid, tartaric acid, citric acid and phosphoric acid.

In one embodiment, the beverage composition may be carbonated.

In particular embodiments, the food or beverage product comprises, based on the total weight of the product, from 0.01 to 1.0 wt.-%, more particularly from 0.05 to 0.5 wt.-% of a composition, the composition comprising:
a) From 1 to 25 wt.-%, more particularly from 5 to 20 wt.-%, still more particularly from 10 to 20 wt.-% of oil phase; and
b) From 0.5 to 5 wt.-%, more particularly from 1 to 3, still more particularly from 1.5 to 2.5 wt.-% of pectins.

In particular embodiments, the food or beverage may have a transparency of less than 50 mm, more particularly less than 40 mm.

In alternative embodiments, the composition may be in the form of a powder which may be prepared by performing the steps of
a) Dissolving a sugar beet pectin and at least one other pectin in water in order to obtain an aqueous phase;
b) Dissolving in the aqueous phase obtained in step a) at least one native or modified carbohydrate;
c) Adding an oil phase to the aqueous phase obtained in step b);
d) Optionally: adjusting the pH by adding citric acid, malic acid, acetic acid, ascorbic acid, lactic acid, tartaric acid, phosphoric acid, or a mixture thereof;
e) Mixing the aqueous phase and the oil phase in order to obtain a composition according to the present disclosure.
f) Applying high shear forces to the composition obtained in step e), in order to obtain an emulsified composition.
g) Spray drying the emulsion obtained in step f).

In respect to step b), the at least one native carbohydrate may be selected from the group comprising gum Arabic from Acacia Senegal or gum Arabic from Acacia Seyal, whereas the at least one modified carbohydrate may be selected from the group comprising starch octenyl succinate, dextrins and maltodextrins.

In further alternative embodiments, the emulsified composition may be sprayed on to fluidized core particles using a pressure, sonic or a pneumatic nozzle, preferably, a two-fluid nozzle, or a three-fluid nozzle which is inserted either on the top (top spray), lateral (lateral spray), tangential (tangential spray), or at the bottom (bottom spray) of the fluidized bed. The emulsion may be applied to the core particles in a spray coating process, wherein the core particles size and particle size distribution are commensurate with the desired final delivery system particle size and particle size distribution. The spray coating process may be performed in a fluidized bed dryer, a drum coater, a pan coater or a Loedige mixer, or any mechanical device, where the particulate core material is put in motion in such a way that the surface of the particles is homogeneously exposed to the spray providing the atomized emulsified composition.

In another embodiment, the present disclosure provides the use of the composition according the present disclosure for obtaining cloudy beverages.

There now follows a series of examples that are provided solely for the purpose of illustration and are not intended to be limiting.

### EXAMPLES

### Example 1: Preparation of Compositions

This example is to illustrate a range of pectins and pectin combinations providing stable and unstable cloudy beverage.

Emulsified compositions 1.1 to 1.6 were obtained by performing, for each of them, the steps of:
1. Preparing an oil phase by mixing 44 g of orange oil, 28.7 g of gum ester (PINOVA TIC Gums, ex glycerol esters of gum resins, 24.8 g sucrose acetate isobutyrate and 2.5 g medium chain triglyceride (Miglyol 812, ex Oleo);
2. Preparing an aqueous phase by
   a. dissolving 20 g of sugar beet pectin and citrus pectin (see respective amounts in Table 2) for 4 hours in 850 g of drinkable grade water, at room temperature and under stirring with a propeller stirrer;
   b. dissolving 1.9 g of potassium sorbate in the solution obtained in step a.;
3. Adding the oil phase to the aqueous phase prepared in step 2., in order to obtain a mixture;
4. Adjusting the pH to 3.4 with citric acid;
5. Completing to 1000 g with drinkable grade water.
6. Mixing the oil phase and the aqueous phase with a Kinematica Polytron rotor-stator mixing equipment at a mixing rate of 15 ′000 rpm for 2 minutes, in order to obtain a composition;
7. Emulsifying the composition obtained in step 6 by passing it three times through a two stage high-pressure homogenizer operating at a second stage valve pressure of 50 bar and a first stage valve pressure of 350 bar, in order to obtain an emulsified composition.

In the above composition 1.1 to 1.6, composition 1.6 was according to the present invention, whereas compositions 1.1 to 1.5 were comparative compositions.

Further emulsified compositions 1.7 to 1.14 were obtained by performing, for each of them, the steps of:
1. Preparing an oil phase by mixing a known amount (see Table 1) of orange flavor, lemon flavor and grapefruit flavor, (all from Givaudan International SA), a known amount of gum ester (PINOVA TIC Gums, ex glycerol esters of gum resins), known amount of sucrose acetate isobutyrate and a known amount of medium chain triglyceride (Miglyol 812, ex Oleo);
2. Preparing an aqueous phase by
   a. dissolving a known amount of sugar beet pectin and citrus pectin (see respective amounts in Table 1) for 4 hours in 850 g of drinkable grade water, at room temperature and under stirring with a propeller stirrer;
   b. dissolving a known amount of potassium sorbate in the solution obtained in step a;
3. Adding the oil phase prepared in step 1. to the aqueous phase prepared in step 2., in order to obtain a mixture;
4. Adjusting the pH to 3.4 with citric acid;
5. Completing to 1000 g with drinkable grade water.
6. Mixing the oil phase and the aqueous phase with a Kinematica Polytron rotor-stator mixing equipment at a mixing rate of 15 ′000 rpm for 2 minutes, in order to obtain a composition;
7. Emulsifying the composition obtained in step 6 by passing it three times through a two stage high-pressure homogenizer operating at a second stage valve pressure of 50 bar and a first stage valve pressure of 350 bar, in order to obtain an emulsified composition.

In the above composition 1.7 to 1.14, composition 1.10 was a comparative composition, whereas all other compositions were according to the present invention. Both grapefruit and lemon oil also comprised flavor ingredients.

TABLE 1

Compositions (ingredient weight in grams (g), percentages (%) are percentage by weight)

| | 1.1 | 1.2 | 1.3 | 1.4 | 1.5 | 1.6 | 1.7 | 1.8 | 1.9 | 1.10 | 1.11 | 1.12 | 1.13 | 1.14 |
|---|---|---|---|---|---|---|---|---|---|---|---|---|---|---|
| | 2% SBP; 10% oil | 2% CP 1; 10% oil | 2% CP 2; 10% oil | 2% CP 3; 10% oil | 2% App; 10% oil | 1% SBP + 1% CP2; 10% oil | 0.8% SBP+ 1.2% CP2; 15% oil | 1% SBP + 1% CP2; 15% oil | 1.2% SBP + 0.8% CP2; 15% oil | 1.5% SBP + 0.0% CP; 15% oil | 1.5% SBP + 0.3% CP2; 15% oil | 1.5% SBP + 0.5% CP2; 15% oil | 1.5% SBP + 0.5% CP2; 15% oil | 1.5% SBP + 0.5% CP2; 15% oil |
| Orange oil | 44 | 44 | 44 | 44 | 44 | 44 | 66 | 66 | 66 | 63 | 63 | 63 | 42.1 | |
| Lemon oil | | | | | | | | | | | | | 17.8 | |
| Grapefruit oil | | | | | | | | | | | | | | 58.5 |
| Gum ester (E445) | 28.7 | 28.7 | 28.7 | 28.7 | 28.7 | 28.7 | 43.1 | 43.1 | 43.1 | 42.8 | 42.8 | 42.8 | 42 | 45 |
| Sucrose acetate isobutyrate | 24.8 | 24.8 | 24.8 | 24.8 | 24.8 | 24.8 | 37.2 | 37.2 | 37.2 | 40.5 | 40.5 | 40.5 | 44.3 | 43 |
| Medium chain triglyceride | 2.5 | 2.5 | 2.5 | 2.5 | 2.5 | 2.5 | 3.7 | 3.7 | 3.7 | 3.7 | 3.7 | 3.7 | 3.8 | 3.5 |
| Potassium sorbate | 1.9 | 1.9 | 1.9 | 1.9 | 1.9 | 1.9 | 1.9 | 1.9 | 1.9 | 1.9 | 1.9 | 1.9 | 1.9 | 1.9 |
| Citric acid | q. s. to adjust pH 3.4 | | | | | | | | | | | | | |
| Sugar beet pectin | 20 | | | | | 10 | 8 | 10 | 12 | 15 | 15 | 15 | 15 | 15 |
| Citrus pectin 1 | | 20 | | | | | | | | | | | | |
| Citrus pectin 2 | | | 20 | | | 10 | 12 | 10 | 8 | 0 | 3 | 5 | 5 | 5 |
| Citrus pectin 3 | | | | 20 | | | | | | | | | | |
| Apple pectin | | | | | 20 | | | | | | | | | |
| Water | q. s. 1000 | q. s. 1000 | q. s. 1000 | q. s. 1000 | q. s. 1000 | q. s. 1000 | q.s. 1000 | q. s. 1000 | q. s. 1000 | q. s. 1000 | q.s. 1000 | q.s. 1000 | q.s. 1000 | q.s. 1000 |
| Droplet diameter (D(50) in micrometer) | 0.191 | 0.933 | 1.65 | 1.99 | 3.81 | 0.371 | 0.996 | 0.547 | 0.617 | 0.396 | 0.420 | 0.416 | 0.4 | 0.44 |
| Beverage transpar-ency (in mm) | 50 | n.d. | 27 | n.d. | n.d. | 34 | 30 | 36 | 38 | 36 | 33 | 30 | 42 | 35 |

TABLE 2

Pectins sub-compositions

| | | |
|---|---|---|
| Description | Supplier | Specification |
| Sugar beet pectin | Herbstreith & Fox, Germany | Betapec RU 301 |
| Citrus pectin 1 | Naturex, Switzerland | Brown Ribbon High Viscosity Citrus 100174 High methoxyl citrus pectin |
| Citrus pectin 2 | Naturex, Switzerland | Pectin VH-127 DO Citrus High methoxyl, non amidated, with sucrose |
| Citrus pectin 3 | Naturex, Switzerland | Pectin VH-177 HV High methoxyl citrus pectin |
| Apple pectin | Roeper, Germany | High methoxyl apple pectin |

Comparison of the emulsification activity of different types of pectin

In compositions 1.1 to 1.5 different types of pectin as single emulsifier were tested. Only composition 1.1 had sufficiently small droplets to ensure stability over time. Surprisingly, composition 1.6, in which sugar beet pectin was combined with citrus pectin, formed stable emulsions as well. The droplet diameter distribution density on a logarithmic abscissa of trials 1.1 (SBP), 1.3 (CP) and 1.6 (SBP+CP) are shown on FIG. 1.

The composition 1.7 with 0.8 wt.-% sugar beet pectin with 15 wt.-% oil was not stable, meaning that the droplet size distribution was shifted to larger diameters over time but all other compositions with 15 wt.-% oil and minimum 1 wt.-% sugar beet pectin provided long term stability.

### Example 2: Beverages

This example is to illustrate beverages and their relevant characteristics.

Beverages containing respectively 100 ppm of orange oil (compositions 1.1 to 1.12), 75 ppm of a combination of orange and lemon oils (composition 1.13) and 100 ppm grapefruit oil (composition 1.14) were produced with above listed emulsified compositions. The stability of the beverages as well as their transparency was assessed.

TABLE 3

Composition of beverages

| Component | Dosage g/ kg |
|---|---|
| Water | q. s. to 1000 |
| Syrup (55° Brix) | 200 |
| Water, cold fill up to 1000 ml | 90.4 |
| Sodium Benzoate | 0.14 |
| Trisodium Citrate | 0.32 |
| Sugar (Powder) | 106.7 |
| Citric Acid Anhydrous (Powder) | 2.4 |
| Composition from Example 1 | |
| Composition 1.1-1.6 | 2.30 |
| Composition 1.7-1.9 | 1.52 |
| Composition 1.10-1.12 | 1.59 |
| Composition 1.13 | 1.12 |
| Composition 1.14 | 1.71 |

Beverages produced with compositions 1.2, 1.3, 1.4, 1.5, and 1.7 showed instabilities like creaming after a short period of time. Beverages produced with compositions 1.6, 1.8 and 1.9 did not show any signs of instability.

In FIG. 2, the transparency of beverages measured 1 day after production showed that the addition of citrus pectin 2 decreased the transparency of the beverages (compositions 1.3 and 1.6).

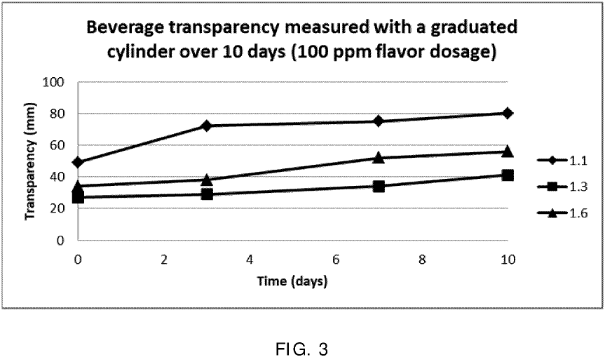

In a trial in which beverage transparency was repeatedly measured over 10 days (FIG. 3), a beverage containing a composition with sugar beet pectin as single emulsifier (composition 1.1) were not stable: their transparency increased over time. Composition 1.3 showed a lower transparency than composition 1.1, but some phase separation (ringing) was observed. A beverage comprising composition 1.6, containing a combination of different pectins, had also a lower transparency than composition 1.1 and was stable over 10 days.

On the other hand, beverages comprising compositions 1.7 to 1.9 confirm that increasing the citrus pectin to sugar beet pectin weight ratio decreases the transparency of the beverage.

Finally, compositions 1.13 and 1.14 show that stable emulsions may be obtained having a favorable droplet diameter for optimum beverage transparency with other oils comprising flavor ingredients.

1. A composition comprising:
a) an oil phase comprising at least one oil product selected from i) a fruit oil and ii) a vegetable oil, a transformed vegetable oil or a vegetable oil fraction; and
b) an aqueous phase comprising sugar beet pectin and at least one other pectin, wherein the at least one other pectin is obtained from a plant that is different from sugar beet.

2. The composition according to claim 1, wherein
the i) fruit oil comprises at least one of a bergamot oil, a grapefruit oil, a lemon oil, a terpene-less lemon oil, a lime oil, a terpene-less lime oil, a mandarin oil, an orange cold pressed oil, an orange essence oil, a tangerine cold pressed oil, and a tangerine essence oil; and
the ii) vegetable oil fraction comprises medium chain triglycerides .

3. The composition according to claim 1, wherein the at least one other pectin is a citrus pectin.

4. The composition according to claim 1, wherein the at least one other pectin has a viscosity of 400 to 500 mPas, when dissolved at an amount of 4 wt.-% in deionized water and measured at 25° C. using a Brookfield LVDV 3 instrument equipped with a Spindel 3, rotating at a speed of 30 rpm, and a degree of esterification of from 60 to 90 wt.-%.

5. The composition according to claim 1, wherein the weight ratio of the sugar beet pectin to the at least one other pectin is from 0.75 to 9.

6. The composition according to claim 1 comprising, based on the total weight of the composition:
a) from 1 to 25 wt.-% of oil phase; and
b) from 0.5 to 5 wt.-%, of pectins.

7. The composition according to claim 1, wherein the composition additionally comprises at least one benefit agent selected from the group consisting of flavor ingredients, vitamins, carotenoids, and antioxidants.

8. The composition according to claim 7, wherein the at least one benefit agent is at least one flavor ingredient selected from the group consisting of 1,1-diethoxyethane; 3-hydroxybutan-2-one; 1-phenylethanone; (Z)-oxacycloheptadec-10-en-2-one; benzaldehyde; 2-methylpropyl acetate; 2-methylpropyl 2-methylbutanoate; butanal; butyric acid; 2-methylpropanoic acid; 2-methyl-5-prop-1-en-2-ylcyclohex-2-en-1-ol; (2E)-3-phenylprop-2-enal; (E)-3,7-dimethylocta-2,6-dienal; 3,7-dimethyloct-6-enal; 3,7-dimethyloct-6-en-1-ol; (E)-1-(2,6,6-trimethylcyclohexa-1,3-dien-1-yl)but-2-en-1-one; 6-pentyl-tetra-hydro-2H-pyran-2-one; 5-hexyloxolan-2-one; decanal; chroman-2-one; methyl 2-(methylamino)benzoate; dimethyl sulfide; oxydibenzene; 1-methyl-4-prop-1-en-2-ylcyclohexene; 5-octyloxolan-2-one; ethyl acetate; ethyl butanoate; ethyl 2-methylpropionate; ethyl 3-phenylprop-2-enoate; ethyl decanoate; 6-ethyl-1,5,5-trimethylbicyclo[2.2.1]heptan-6-ol; ethyl formate; ethyl heptanoate; ethyl hexanoate; ethyl 3-hydroxybutanoate; ethyl 3-hydroxyhexanoate; ethyl 2-methylbutanoate; ethyl octanoate; ethyl 3-methylbutanoate; ethyl propionate; 4-ethylphenol; pent-1-en-3-one; 2-methyl-5-propan-2-ylcyclohexa-1,3-diene; 7,11-dimethyl-3-methylidenedodeca-1,6,10-triene; 2-ethyl-4-hydroxy-5-methylfuran-3-one; (E)-3,7-dimethylocta-2,6-dien-1-ol; (E)-3,7-dimethylocta-2,6-dien-1-yl acetate; hexanal; hexanoic acid; (E)-hex-2-enal; (Z)-hex-3-en-1-ol; (Z)-hex-3-en-1-yl acetate; (E)-4-(2,6,6-trimethyl-1-cyclohex-2-enyl)but-3-en-2-one; (E)-4-(2,6,6-trimethyl-cyclohex-1-en-1-yl)but-3-en-2-one; 3,7-dimethylocta-1,6-dien-3-ol; 3,7-dimethylocta-1,6-dien-3-yl acetate; 3-hydroxy-2-methyl-4H-pyran-4-one; 4-methyl-4-sulfanylpentan-2-one; 2-(4-methylcyclo-hex-3-en-1-yl)propane-2-thiol; mercapto-para-menthan-3-one; methyl acetate; methyl 2-aminobenzoate; 2-methylbutanoic acid; methyl 3-phenylprop-2-enoate; methyl 3-oxo-2-pentylcyclopentaneacetate; 5-methylfuran-2-carbaldehyde; 7-methyl-3-methyleneocta-1,6-diene; (Z)-3,7-dimethylocta-2,6-dien-1-yl acetate; 5-pentyloxolan-2-one; nonanal; 4,4a-dimethyl-6-(prop-1-en-2-yl)-4,4a,5,6,7,8-hexahydronaphthalen-2(3H)-one; 5-butyloxolan-2-one; octanal; octanoic acid; orris concrete; osmanthus absolute; 2,3-pentanedione; 3-methylbutyl acetate; 3-methylbutyl 3-methylbutanoate; propyl acetate; rose oil; (2E,6E,9E)-2,6,10-trimethyldodeca-2,6,9,11-tetraenal; (2E,6E)-2,6-dimethyl-10-methylidenedodeca-2,6,11-trienal; tarragon oil; 4-methyl-1-propan-2-ylcyclohex-3-en-1-ol; 1-methyl-4-propan-2-ylcyclohexa-1,3-diene; 2-(4-methyl-1-cyclohex-3-enyl)propan-2-ol; 1-methyl-4-(propan-2-ylidene)cyclohex-1-ene; 2-(4-methylcyclohex-3-en-1-yl)propan-2-yl acetate; 4a,5-dimethyl-3-prop-1-en-2-yl-2,3,4,5,6,7-hexahydro-1H-naphthalene; 4-hydroxy-3-methoxybenzaldehyde; and mixtures thereof.

9. The composition according to claim 1, wherein the composition additionally comprises at least one preservative.

10. The composition according to claim 1, wherein the oil phase is dispersed in the aqueous phase in the form of dropletsto form an oil-in-water emulsion.

11. The composition according to claim 10, wherein the oil droplets have a volume-median diameter of from 0.2 to 0.7 µm.

12. The composition according to claim 10, wherein the composition additionally comprises a weighting agent, wherein the weighting agent is selected from the group consisting of sucrose esters, polyol fatty acid esters, polyol benzoates, dammar gum, rosin gums, ester gums, and combinations thereof, and wherein the amount of the weighting agent is up to 70 wt.-% based on the total amount of oil phase contained in the composition.

13. The composition according to claim 1, wherein the composition has a pH of 5 or less.

14. A method for obtaining the composition according to claim 1 comprising the steps of:
a) preparing the oil phase;
b) preparing the aqueous phase comprising a sugar beet pectin and at least one other pectin;
c) mixing the aqueous phase and the oil phase in order to obtain a composition; and optionally,
d) adjusting the pH by adding citric acid, malic acid, acetic acid, ascorbic acid, lactic acid, tartaric acid, phosphoric acid, or a mixture thereof;
wherein step a) and step b) are interchangeable,
wherein in step c) the pectins are optionally added after having mixed the water and the oil phase, and
wherein the pH is optionally adjusted before adding the oil phase in step c) or after.

15. The method according to claim 14, additionally comprising the step of adding at least one benefit agent selected from the group consisting of flavor ingredients, vitamins, carotenoids, and antioxidants.

16. The method according to claim 14 additionally comprising the a step of adding at least one preservative.

17. The method according to claim 14 additionally comprising astep of applying high pressure homogenization to the composition in order to form an emulsified composition.

18. A composition obtained by the method according to claim 14.

19. A food or beverage product comprising the composition according to claim 1.

20. A food or beverage product comprising, based on the total weight of the product, from 0.01 to 1.0 wt-% of the composition according to claim 1.
